(19) United States
(12) Patent Application Publication
(10) Pub. No.: US 2005/0116447 A1
(43) Pub. Date: Jun. 2, 2005

(54) Front pillar trim mounting structure of vehicle

(75) Inventor: Seung-Soo Ryu, Gyeonggi-do (KR)

Correspondence Address: EDWARDS & ANGELL, LLP, P.O. BOX 55874, BOSTON, MA, 02205, US

(73) Assignee: Kia Motors Corporation, Seoul (KR)

(21) Appl. No.: 11/001,800

(22) Filed: Dec. 1, 2004

(30) Foreign Application Priority Data
Dec. 2, 2003 (KR) 10-2003-0086728

(51) Int. Cl. B60R 21/16; B60R 21/22

(52) U.S. Cl. 280/728.2; 280/730.1

(57) ABSTRACT

A front pillar trim mounting structure coupled to a front pillar inner panel in a vehicle having a curtain air bag module is provided. In a preferred system of the invention, a front pillar trim is coupled to a front pillar inner panel by inserting a coupling protrusion (formed at the front pillar trim) into an insertion fixture (formed at the front pillar inner panel). When the airbag cushion inflates, the front pillar trim is not completely separated from the front pillar inner panel by the coupling force of the coupling protrusion disposed in the insertion fixture.

### CROSS-REFERENCE TO RELATED APPLICATIONS

The present application is based on, and claims priority from, Korean Application Serial Number 10-2003-0086728, filed on Dec. 2, 2003, the disclosure of which is hereby incorporated by reference herein in its entirety.

### FIELD OF THE INVENTION

The present invention relates to a front pillar trim mounting structure coupled to a front pillar inner panel in a vehicle having a curtain air bag module.

### BACKGROUND OF THE INVENTION

Generally, a curtain air bag module is equipped in a vehicle to help protect occupants against injury in the event of a side impact or rollover.

In a front curtain air bag module, an airbag cushion is located between a front pillar inner panel and front pillar trim.

When the curtain air bag module operates, the airbag cushion inflates toward the upper torso of the occupants by expanding the space between the front pillar trim and front pillar inner panel. However, the front pillar trim should not be separated from the front pillar inner panel because if the front pillar trim completely separates from the front pillar inner panel, then the front pillar trim may fall and injure vehicle occupants.

The information disclosed in this Background of the Invention section is only for enhancement of understanding of the invention and should not be taken as an acknowledgement or any form of suggestion that this information forms the prior art that is already known to a person skilled in the art.

### SUMMARY OF THE INVENTION

In one aspect, the present invention provides systems to prevent a complete separation of a front pillar trim from a front pillar inner panel when an airbag cushion inflates.

More particularly, in a preferred system of the invention, a front pillar trim mounting structure comprises a front pillar inner panel formed with an insertion hole. A front pillar trim is fixed to the front pillar inner panel. A coupling protrusion protrudes out from the inside of the front pillar trim and penetrates the insertion hole. An airbag cushion is positioned proximate to the coupling protrusion, at a space between the coupling protrusion and a part that connects the lower portion of the front pillar inner panel and the lower portion of the front pillar trim, wherein the space is formed within the enclosure of the front pillar inner panel and front pillar trim.

The invention also comprises vehicles that contain the described mounting structures, including vehicles that comprise a curtain air bag module.

It is understood that the term “vehicle” or other similar term as used herein is inclusive of motor vehicles in general such as passenger automobiles, buses, trucks, various commercial vehicles, and the like.

Other aspects of the invention are discussed below.

### BRIEF DESCRIPTION OF THE DRAWINGS

For a better understanding of the nature and objects of the present invention, reference should be made to the following detailed description with the accompanying drawings, in which:

FIG. 1 is a prospective view of a front pillar inner panel and a front pillar trim according to an embodiment of the present invention;

FIG. 2 is a cross-sectional view taken along line II-II of FIG. 1 for illustrating the coupled state of a front pillar inner panel and front pillar trim; and

FIG. 3 is a cross-sectional view illustrating an operation state of a front pillar trim during deployment of an airbag cushion compared to FIG. 2.

### DETAILED DESCRIPTION OF THE INVENTION

As discussed, the invention provides a front pillar trim mounting structure that suitably comprises: a front pillar inner panel comprising an insertion fixture such as an insertion hole or other mating element; a front pillar trim associated with (e.g. affixed to) the front pillar inner panel; a coupling protrusion protruding from the front pillar trim and mating with the insertion fixture; and an airbag cushion positioned between the coupling protrusion and a part connecting the front pillar inner panel and the front pillar trim.

One or more preferred embodiments of the present invention now will be described in detail with reference to the attached drawings.

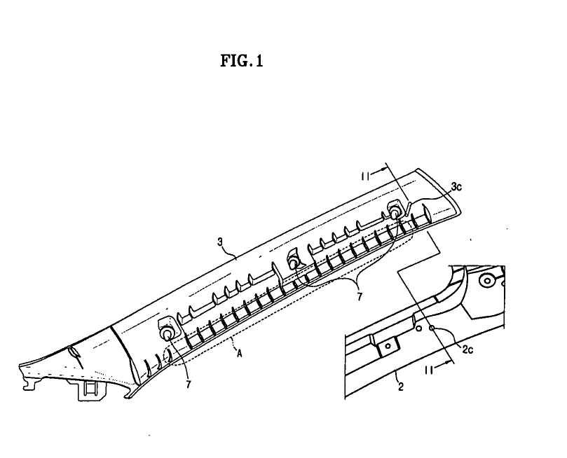

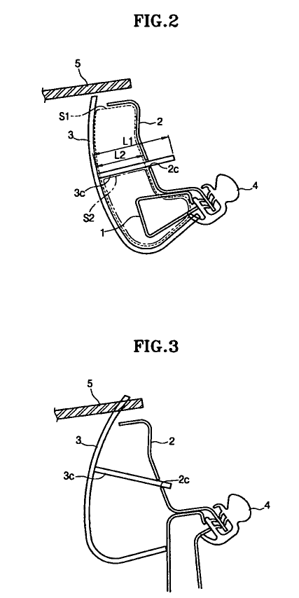

Referring to FIGS. 1 and 2, a front pillar trim mounting structure of a vehicle according to a preferred embodiment of the present invention suitably includes a front pillar inner panel 2 formed with an insertion hole 2c. A front pillar trim 3 is suitably fixed to the front pillar inner panel 2. A coupling protrusion 3c suitably protrudes from the inside of the front pillar trim 3 and penetrates the insertion hole 2c. An airbag cushion 1 is suitably placed in close proximity to the coupling protrusion 3c, at a space (S2) between the coupling protrusion 3c and the part that connects the lower portion of the front pillar inner panel 2 and the lower portion of the front pillar trim 3, wherein the S2 is formed within an enclosure (S1) of the front pillar inner panel 2 and front pillar trim 3.

The lower connecting part of the front pillar inner panel 2 and front pillar trim 3 is suitably sealed for example via a weather strip 4 or other suitable sealing methods and materials. The upper connecting part of the front pillar inner panel 2 and front pillar trim 3 is preferably closely attached to a windshield 5 and is preferably sealed such as via another weather strip (not shown) or other suitable sealing methods and materials.

The insertion hole 2c is preferably slightly larger in diameter than that of the coupling protrusion 3c. The size of the insertion hole 2c, however, preferably should be appropriately formed to prevent the coupling protrusion 3c from completely escaping from the insertion hole 2c when the airbag cushion 1 inflates.

The overall length of the coupling protrusion 3c (L1) is preferably formed longer than a linear length (L2)—the length from the inner side of the front pillar trim 3 to the insertion hole 2c—in order to prevent or avoid the coupling protrusion 3c from separating from the insertion hole 2c during deployment of the airbag cushion 1.

If the coupling protrusion 3c completely separates from the insertion hole 2c when the airbag cushion 1 inflates, then the front pillar trim 3 can break away from the front pillar inner panel 2, potentially causing injury to the occupants. Therefore, the coupling protrusion 3c should not be separated from the insertion hole 2c during deployment of the airbag cushion 1.

The L1 in the embodiment of the present invention preferably is at least 1.5 times longer than L2 (the length from the inside of the front pillar trim 3 to the insertion hole 2c).

The element numeral 7 in FIG. 1 refers to clip members that suitably couple the front pillar trim 3 to the front pillar inner panel 2.

The front pillar inner panel 2 is suitably formed with coupling holes (not shown) to couple with the clip members 7. The clip members are preferably configured to easily separate from the coupling holes by inflation pressure of the airbag cushion 1.

In operation of a preferred system of the invention, when a heavy impact is transmitted to the vehicle body while the vehicle is in motion, gas is emitted from the exploded inflator. The airbag cushion 1 folded between the front pillar inner panel 2 and front pillar trim 3 inflates downwardly into the passenger compartment by distancing the lower end (A) of the front pillar trim 3 from the front pillar inner panel 2, thus the airbag cushion 1 is enclosed with the door panel (see FIG. 3).

In reference to FIG. 3, the front pillar trim 3 being distanced from the front pillar inner panel 2 via the inflation pressure of the airbag cushion 1 is restrained in the movement thereof by the fixing force of the coupling protrusion 3c, which is tightly fixed in the insertion hole 2c. Thus, the front pillar trim 3 does not completely separate from the front pillar inner panel 2 even upon inflation of the airbag cushion 1.

When the airbag cushion 1 is deployed, the front pillar trim 3 thus constructed does not completely detach from the front pillar inner panel 2 due to the coupling force of the coupling protrusion 3c (mounted at the front pillar trim 3) and the insertion hole 2c (formed on the front pillar inner panel 2), thus protecting the occupants from injury.

By simply inserting the coupling protrusion 3c into the insertion hole 2c, a separation of the front pillar trim 3 from the front pillar inner panel 2 can be prevented. Such systems of the invention also can provide a reduction of manpower and manufacturing costs as well as improvement of the workability and the production capacity of the vehicle.

In order to reliably prevent a complete separation of the coupling protrusion 3c from the insertion hole 2c while the airbag cushion 1 inflates, the coupling protrusion 3c and the insertion hole 2c may be formed unevenly, with thread engagement (e.g., screw-thread shape) or the like so as to increase the frictional force of the outer surface of the coupling protrusion and the inner surface of the insertion hole.

As indicated by the foregoing, preferred systems of the invention can provide notable advantages where a front pillar trim is coupled to a front pillar inner panel by inserting a coupling protrusion (formed at the front pillar trim) into an insertion hole (formed at the front pillar inner panel), and the front pillar trim is not completely separated, when the airbag cushion inflates, from the front pillar inner panel by the coupling force of the coupling protrusion disposed in the insertion hole. Among other things, as discussed above, manpower and manufacturing costs can be reduced and production capacity of the vehicle increased.

While the invention has been described with reference to specific embodiments, modifications and variations of the invention may be constructed without departing from the scope of the invention, which is defined in the following claims.

1. A front pillar trim mounting structure, comprising:
a front pillar inner panel formed with an insertion hole;
a front pillar trim fixed to the front pillar inner panel;
a coupling protrusion protruding from the inside of the front pillar trim and penetrating the insertion hole; and
an airbag cushion proximate to the coupling protrusion and positioned between the coupling protrusion and a part connecting a lower portion of the front pillar inner panel and a lower portion of the front pillar trim.

2. The structure as defined in claim 1, wherein the coupling protrusion is at least about 1.5 times longer than a length from the inside of the front pillar trim to the insertion hole.

3. A front pillar trim mounting structure, comprising:
a front pillar inner panel comprising an insertion fixture;
a front pillar trim associated with the front pillar inner panel;
a coupling protrusion protruding from the front pillar trim and mating with the insertion fixture; and
an airbag cushion positioned between the coupling protrusion and a part connecting the front pillar inner panel and the front pillar trim.

4. The structure of 3 wherein the coupling protrusion is at least about 1.5 times longer than a length from the inside of the front pillar trim to the insertion hole.
